(19) United States
(12) Patent Application Publication
(10) Pub. No.: US 2010/0295658 A1
(43) Pub. Date: Nov. 25, 2010

(54) INTELLIGENT LOCK

(76) Inventor: Shu-Chin Chen, Zhubei City (TW)

Correspondence Address: RABIN & Berdo, PC, 1101 14TH STREET, NW, SUITE 500, WASHINGTON, DC, 20005, US

(21) Appl. No.: 12/469,856

(22) Filed: May 21, 2009

(51) Int. Cl. G06F 7/04

(52) U.S. Cl. 340/5.83; 340/5.84

(57) ABSTRACT

The present invention provides an intelligent lock including an image recognition system, a voiceprint recognition system and a fingerprint recognition system. These recognition systems can recognize a built-in recognition data of the lock. If the built-in recognition data of the lock is matched, then the lock can be opened immediately, or else an alarm will be triggered.

### BACKGROUND OF THE INVENTION

1. Field of the Invention

The present invention relates to an intelligent lock, and more particularly to an intelligent lock having image, voiceprint and fingerprint recognition systems and a database for storing a plurality of image, voiceprint and fingerprint data, such that when a user opens the lock, the user's image, voiceprint and fingerprint are compared by the recognition systems of the lock. If all of the user's data match the data in the database, then the lock will be opened immediately, or else an alarm will be triggered.

2. Description of the Related Art

In general, a traditional lock requires a key or a password. If the key is missing or the password is forgotten, then it will take a while and much effort before we can open the lock. As science and technology advance, the traditional lock can be opened easily by unauthorized persons, and thus causing panics to users in their daily life.

In view of the foregoing shortcomings of the prior art, the inventor of the present invention, based on years of experience in the related industry, conducted extensive researches and experiments, and finally developed an intelligent lock in accordance with the present invention.

### SUMMARY OF THE INVENTION

The primary objective of the present invention is to combine image, voiceprint and fingerprint recognition systems, for opening a lock immediately as long as the data built in the image, voiceprint and fingerprint recognition systems are matched.

Another objective of the present invention is to trigger an alarm if any data inputted by the user does not match the lock recognition systems.

### BRIEF DESCRIPTION OF THE DRAWING

FIG. 1 shows a schematic block diagram of the invention.

### DETAILED DESCRIPTION OF THE PREFERRED EMBODIMENTS

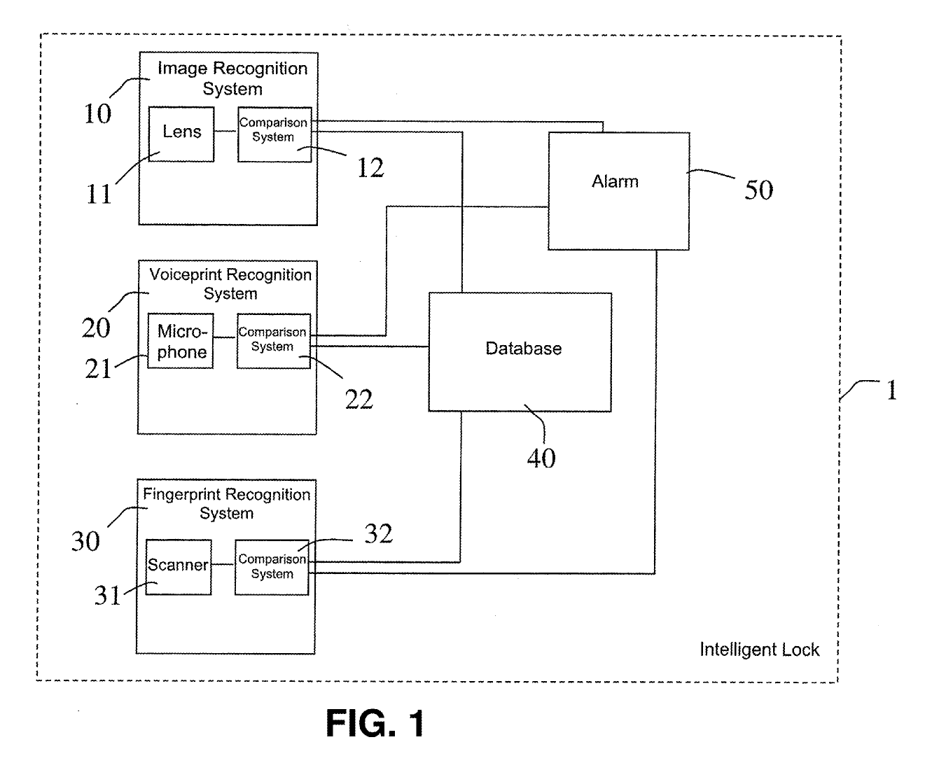

With reference to FIG. 1, an intelligent lock 1 comprises: an image recognition system 10, a voiceprint recognition system 20, a fingerprint recognition system 30, a database 40 and an alarm 50.

The image recognition system 10, the voiceprint recognition system 20 and the fingerprint recognition system 30 are linked to the database 40, such that when a user opens the lock, the user's figure is recorded by a lens 11 of the image recognition system 10 and transmitted to a comparison system 12, and an image data built in the database 40 is transmitted to the comparison system 12 for a comparison.

In addition to recording an image of the user's figure through the lens 11 of the image recognition system 10, the user also produces a sound through a microphone 21 of the voiceprint recognition system 20 and scans the user's fingers by a scanner 31 of the fingerprint recognition system 30.

A sound data recorded by the microphone 21 and a fingerprint data scanned by the scanner 31 are transmitted to a comparison system 22, 32 of the voiceprint recognition system 20 and the fingerprint recognition system 30. Meanwhile, the voiceprint and fingerprint data originally built in the database 40 are transmitted to the comparison system 22, 32 for the comparison. If the user's image, voiceprint and fingerprint data match the data in the database 40, the intelligent lock 1 will be opened immediately.

If any data inputted by the user does not match with the data in the database after going through the comparisons by the image recognition system 10, the voiceprint recognition system 20 and the fingerprint recognition system 30, then the alarm 50 will be triggered.

What is claimed is:

1. An intelligent lock, comprising:
an image recognition system, linked to a database, for comparing an image recorded through a lens with an image data in the database by a comparison system to recognize whether or not the image recorded through the lens matches with the image data in the database;
a voiceprint recognition system, linked to the database, for comparing a sound received by a microphone for a voice comparison and recognition, and recognizing whether or not a voiceprint received by the microphone matches with a voiceprint data in the database;
a fingerprint recognition system, linked to the database, for performing a fingerprint comparison and recognition for a fingerprint data scanned by a scanner, and recognize whether or not the scanned fingerprint matches with a fingerprint data in the database;
a database, including a plurality of built-in image data, voiceprint data and fingerprint data provided for the image recognition system, the voiceprint recognition system and the fingerprint recognition system for performing a comparison and a recognition; and
an alarm, coupled to the image recognition system, the voiceprint recognition system and the fingerprint recognition system, such that the arm will be triggered, if the data recognized by the image recognition system, the voiceprint recognition system and the fingerprint recognition system is not matched.
